(19) United States
(12) Patent Application Publication
(10) Pub. No.: US 2007/0138813 A1
(43) Pub. Date: Jun. 21, 2007

(54) Hold-open lock structure of sliding door

(76) Inventor: Jung-Hoon Park, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/524,928

(22) Filed: Sep. 21, 2006

(30) Foreign Application Priority Data
Dec. 10, 2005 (KR) 10-2005-0121271

(51) Int. Cl. E05B 3/00

(52) U.S. Cl. 292/336.3

(57) ABSTRACT

A hold-open lock structure of a sliding door, in which, when the inner handle of the sliding door is manipulated to open the sliding door, a hold-open lock is not released, thus preventing a safety hazard from occurring when the vehicle is parked on a slope due to the sliding door not being locked open and moving closed due to its own weight when the inner handle is released after the sliding door has been opened.

### CROSS-REFERENCE TO RELATED APPLICATIONS

The present application is based on, and claims priority from, Korean Application Serial Number 10-2005-0121271, filed on Dec. 10, 2005, the disclosure of which is hereby incorporated by reference herein in its entirety.

### FIELD OF THE INVENTION

The present invention relates to sliding doors for vehicles and, more particularly, to a hold-open lock structure of a sliding door in which, when an inner handle of the sliding door is manipulated, a hold-open lock is operated so that even if the sliding door is opened on a slope, the sliding door maintains a locked-open state.

### BACKGROUND OF THE INVENTION

Generally, vehicle doors are mounted to a vehicle body to openably close the passenger compartment. A sliding door is one example of such a vehicle door.

The sliding door, when opened or closed, is moved along a rail, which is mounted on the vehicle body. Inner and outer handles for opening or closing the sliding door are respectively provided on the inner and outer sidewalls of the sliding door.

The inner handle, which is provided inside the sliding door, is rotatably coupled at a first end thereof to a door panel of the sliding door by a hinge.

An actuating lever is coupled to the inner handle so as to be integrally rotatable along with the inner handle. An inner handle link is coupled at a first end thereof to the actuating lever so as to be operated in conjunction with the actuating lever. The inner handle link is coupled at a second end thereof to the inner handle lever, which is rotatably coupled to the door panel.

The inner handle lever is coupled to an outer handle lever by a pin. An outer handle rod is coupled at a first end thereof to the outer handle lever and is coupled at a second end thereof to a hold-open lock lever. An inner handle rod, which is coupled to the hold-open lock, is coupled to the hold-open lock lever.

When a user rotates the inner handle, for example, in a clockwise direction, the actuating lever is integrally rotated along with the inner handle, thus pulling the inner handle link. The inner handle lever is thus rotated in a clockwise direction by the inner handle link pulled by the actuating lever. By the rotation of the inner handle lever, the outer handle rod is pushed downwards and, simultaneously, the hold-open lock lever is rotated in a clockwise direction. The inner handle link is pushed by the rotation of the hold-open lock lever. As a result, the hold-open lock is released.

However, in the conventional hold-open lock structure of the sliding door, when the vehicle is in a stopped or parked state on a slope, if the user completely opens the sliding door through manipulation of the inner handle and releases the inner handle, because the sliding door has been in the state in which the hold-open lock is released by manipulation of the inner handle, there is the probability of a safety hazard due to the sliding door, which is not locked open.

### SUMMARY OF THE INVENTION

Embodiments of the present invention provide a hold-open lock structure of a sliding door such that, when an inner handle of the sliding door is manipulated to open the sliding door, a hold-open lock is not released, thus preventing safety hazards occurring on a slope due to the sliding door not being locked open but being undesirably moved in the closing direction by its own weight when the inner handle is released after the sliding door has been opened.

A hold-open lock structure of a sliding door according to an embodiment of the present invention includes an inner handle which is rotatably mounted at an end thereof to a door panel through a rotating shaft. First and second release levers are coupled to the rotating shaft so as to be integrally rotatable along with the rotating shaft of the inner handle. An inner handle link is coupled at a first end thereof to the first release lever. An inner handle lever is rotatably mounted to the door panel and coupled to a second end of the inner handle link. A slot is formed at a predetermined position through the inner handle lever. An outer handle lever is rotatably mounted to the door panel-and coupled to the slot of the inner handle lever through a pin. An outer handle rod is coupled at a first end thereof to the outer handle lever. A hold-open lock lever is rotatably mounted to the door panel and coupled to a second end of the outer handle rod. An inner handle rod is coupled at a first end thereof to the hold-open lock lever and coupled at a second end thereof to the second release lever. A return spring is provided on each of the inner handle lever and the outer handle lever.

### BRIEF DESCRIPTION OF THE DRAWINGS

For a better understanding of the nature and objects of the present invention, reference should be made to the following detailed description with the accompanying drawings, in which:

FIG. 1 is a front view of a hold-open lock structure of a sliding door, according to an embodiment of the present invention; and

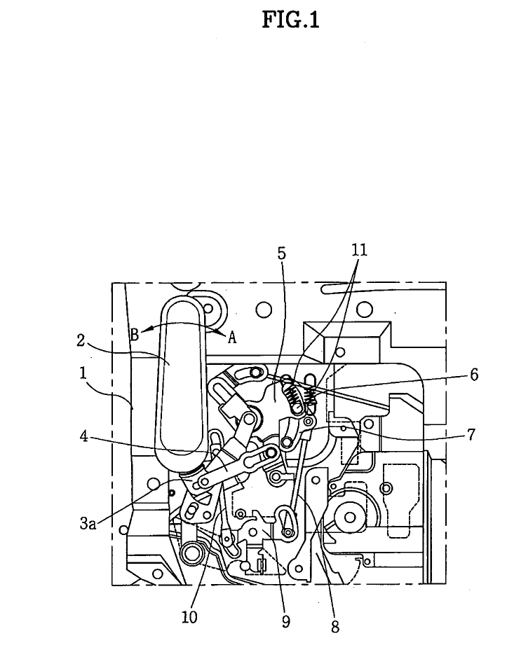

FIG. 2 is a detailed view showing specific components of the lock structure shown in FIG. 1.

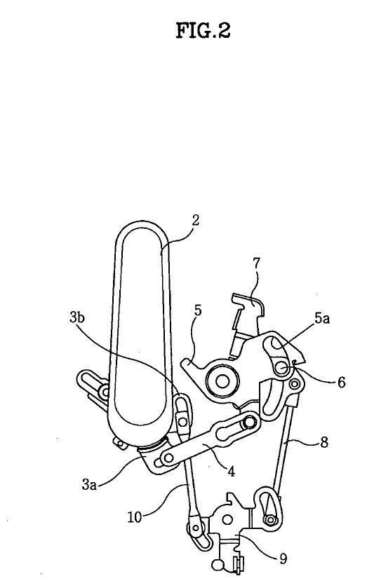

### DETAILED DESCRIPTION OF THE PREFERRED EMBODIMENTS

Hereinafter, a preferred embodiment of the present invention will be described in detail with reference to the attached drawings.

Referring to the drawings, an inner handle 2 is mounted at an end thereof to a door panel 1 so as to be rotatable around a rotating shaft in a clockwise or counterclockwise direction. First and second release levers 3a and 3b are coupled to the rotating shaft of the inner handle 2 so as to be rotatable along with the rotating shaft of the inner handle 2.

The first release lever 3a has a slot therein. A first end of an inner handle link 4 is coupled to the first release lever 3a through the slot using a pin, so that the inner handle link 4 is operated in conjunction with the first release lever 3a. A slot is formed through a second end of the inner handle link 4. An inner handle lever 5 is coupled to the inner handle link 4 through the slot of the inner handle link 4 using a pin, such that they are operated in conjunction with each other.

The inner handle lever 5 is mounted to the door panel 1 using a pin so as to be rotatable in a clockwise or counterclockwise direction. A slot 5a is formed at a predetermined position through the inner handle lever 5, and an outer handle lever 7 is coupled to the slot 5a of the inner handle lever 5 through a pin 6. An outer handle rod 8 is coupled at a first end thereof to the outer handle lever 7 such that they are operated in conjunction with each other.

The outer handle rod 8 is coupled at a second end thereof to a first end of a hold-open lock lever 9 using a pin through a slot, which is formed through the first end of the hold-open lock lever 9. The hold-open lock lever 9 is rotatably mounted to the door panel 1 using a pin. An inner handle rod 10 is coupled at a first end thereof to a second end of the hold-open lock lever 9 using a pin through a slot, which is formed through the second end of the hold-open lock lever 9. The inner handle rod 10 is coupled at a second end thereof to the second release lever 3b.

Furthermore, a first end of a return spring 11 is locked to the outer handle lever 7, and a second end of the return spring 11 is locked to the door panel. The return spring 11 thus serves to return the outer handle lever 7 to the original position thereof after the operation of the outer handle lever 7 is completed. A return spring 11 is also coupled to the inner handle lever 5 to return the inner handle lever 5 to the original position thereof after the operation of the inner handle lever 5 is completed.

When the inner handle 2 is rotated in a direction A, in which the door is opened, the first release lever 3a is integrally rotated along with the inner handle 2. The rotation of the first release lever 3a is transmitted to the inner handle link 4, thus pulling the inner handle link 4.

When the inner handle link 4 is pulled, the inner handle lever 5 is rotated in a clockwise direction. At this time, due to the slot formed in the inner handle lever 5, even through the inner handle lever 5 rotates, the outer handle lever 7 does not move while the pin 6 of the outer handle lever 7 moves with respect to the slot of the inner handle lever 5.

Therefore, the outer handle rod 8, the hold-open lock lever 9 and the inner handle rod 10 do not move. Thus, on a slope, even after the sliding door is completely opened by manipulation of the inner handle, the sliding door maintains a state of being locked to the hold-open lock and of being open, thus preventing injury to a user due to the sliding door undesirably moving in the closing direction due to its own weight after the sliding door has been opened.

Meanwhile, when the inner handle 2 is rotated in the direction B, in which the sliding door is closed, the second release lever 3b is integrally rotated along with the inner handle 2. The inner handle rod 10 is pulled by the rotation of the second release lever 3b. Then, the hold-open lock lever 9 is rotated in a clockwise direction. As a result, the hold-open lock is released.

As is apparent from the foregoing, in a hold-open lock structure of a sliding door according to the present invention, when an inner handle is rotated in the direction in which the sliding door is opened, a hold-open lock is not released. Therefore, on a slope, even if the inner handle is released after the sliding door has been completely opened; the sliding door maintains a locked state due to the operation of the hold-open lock. Therefore, the present invention eliminates the possibility of a safety hazard occurring on a slope due to a sliding door that is not locked open but is undesirably moved in the closing direction by its own weight when the inner handle is released after the sliding door has been opened.

What is claimed is:

1. A hold-open lock structure of a sliding door, comprising:
an inner handle rotatably mounted at an end thereof to a door panel through a rotating shaft; first and second release levers coupled to the rotating shaft so as to be rotatable along with the rotating shaft of the inner handle;
an inner handle link coupled at a first end thereof to the first release lever;
an inner handle lever rotatably mounted to the door panel and coupled to a second end of the inner handle link, with a slot formed through the inner handle lever;
an outer handle lever rotatably mounted to the door panel and coupled to the slot of the inner handle lever through a pin;
an outer handle rod coupled at a first end thereof to the outer handle lever;
a hold-open lock lever rotatably mounted to the door panel and coupled to a second end of the outer handle rod;
an inner handle rod coupled at a first end thereof to the hold-open lock lever and coupled at a second end thereof to the second release lever; and
a return spring provided on each of the inner handle lever and the outer handle lever.

2. The hold-open lock structure of the sliding door as defined in claim 1, wherein a slot is formed through the second end of the inner handle link, so that the inner handle link is coupled to the inner handle lever through the slot of the inner handle link using a pin.
